(19) United States
(12) Patent Application Publication
(10) Pub. No.: US 2025/0337562 A1
(43) Pub. Date: Oct. 30, 2025

(54) VEHICLE TERMINAL, METHOD AND SYSTEM FOR ISSUING AUTHENTICATION KEY FOR THE SAME AND VEHICLE INCLUDING THE SAME

(71) Applicants: Hyundai Motor Company, Seoul (KR); Kia Corporation, Seoul (KR)

(72) Inventor: Jae Yoon Ko, Yongin-Si (KR)

(21) Appl. No.: 18/943,387

(22) Filed: Nov. 11, 2024

(30) Foreign Application Priority Data
Apr. 29, 2024 (KR) 10-2024-0057095

(51) Int. Cl. H04L 9/08; H04W 4/44

(52) U.S. Cl. CPC H04L 9/0819; H04W 4/44

(57) ABSTRACT

The disclosure relates to a vehicle terminal, a method and system for issuing an authentication key for the vehicle terminal, and a vehicle incorporating the vehicle terminal, all capable of enhancing security in the authentication key issuance process for the vehicle terminal. A vehicle terminal may include a communication module configured to communicate with a server, and a processor configured to receive authentication key configuration information from the server, request authentication key issuance to the server upon receiving the authentication key configuration information, receive a first remote service request message transmitted from the server as an encrypted short message in response to the authentication key issuance request, request authentication key information to the server, based on a sender number contained in the first remote service request message matching a sender number contained in the authentication key configuration information, to receive an authentication key.

### CROSS REFERENCE TO RELATED APPLICATION(S)

The present application claims the benefit of priority to Korean Patent Application No. 10-2024-0057095, filed on Apr. 29, 2024, in the Korean Intellectual Property Office, the entire contents of which are incorporated by reference herein for all purposes.

### BACKGROUND

### Field

The disclosure relates to authentication key issuance for vehicle terminals.

### Description

Various systems are installed in vehicles to provide information and entertainment. These systems may include various types of terminals (also referred to as vehicle terminals or connected car terminals) that connect to servers, via a mobile communication network operated by a mobile carrier, to deliver services.

For communication security, vehicle terminals may communicate with servers using authentication keys issued by the servers upon request from the vehicle terminals.

When a server receives a request for authentication key issuance from a vehicle terminal, the server may check the vehicle identification number (VIN) of the vehicle and the modem information of the vehicle terminal, and when the information matches, the server may issue the authentication key to the vehicle.

However, if the VIN or the modem information of the vehicle terminal has leaked, the issuance of authentication keys to the vehicle terminal can be compromised. Therefore, there is a need for an enhanced security technology of f issuing authentication keys for vehicle terminals.

This background technology constitutes information the inventor possessed for the derivation of the disclosure or acquired during development, other than prior art publicly disclosed to the public before the filling of the disclosure.

### SUMMARY

The embodiments of the disclosure have been conceived to meet the aforementioned needs by providing a vehicle terminal, a method and system for issuing authentication keys for the terminal, and a vehicle incorporating the terminal, all designed to enhance security during the authentication key issuance process.

The embodiments aim to provide a vehicle terminal, a method and system for issuing an authentication key for the vehicle terminal, and a vehicle incorporating the terminal, all capable of enhancing security in the authentication key issuance process for vehicle terminal by performing the processes of issuing an authentication key and storing the issued key in the vehicle terminal based on communication between the vehicle terminal and the server.

The embodiments aim to provide a vehicle terminal, a method and system for issuing an authentication key for the vehicle terminal, and a vehicle incorporating the terminal, all capable of automatically renewing the authentication key for the vehicle terminal between the vehicle terminal and the server.

The embodiments aim to provide a vehicle terminal, a method and system for issuing an authentication key for the vehicle terminal, and a vehicle incorporating the vehicle terminal, all capable of easily setting the expiration date and renewal period of the authentication key without requiring software changes to the vehicle terminal even when changes occur due to security policy updates.

The technical objects of this disclosure are not limited to the aforesaid, and other objects not described herein with can be clearly understood by those skilled in the art from the descriptions below.

To accomplish the above objects, a vehicle terminal, a method and system for issuing authentication keys for the terminal, and a vehicle incorporating the terminal, all designed to enhance security during the authentication key issuance process, are provided.

According to an embodiment of the disclosure, a vehicle terminal may include a communication module configured to communicate with a server, and a processor configured to receive authentication key configuration information from the server, request authentication key issuance to the server upon receiving the authentication key configuration information, receive a first remote service request message transmitted from the server as an encrypted short message after the authentication key issuance request, request authentication key information to the server, based on a sender number contained in the first remote service request message matching a sender number contained in the authentication key configuration information, to receive an authentication key.

According to an embodiment, the processor may request service activation to the server and receive the authentication key configuration information in response to the service activation request.

According to an embodiment, the processor may request, based on the sender number of the first remote service request message matching the sender number contained in the authentication configuration information, the content of the first remote service request message to the server and request, upon receiving an authentication key storage request message, the authentication key information to the server.

According to an embodiment, the processor may request, based on an authentication renewal period contained in the authentication key configuration information, authentication key renewal to the server and receive a renewal authentication key in response to the authentication renewal request.

According to an embodiment, the processor may receive a second remote service request message transmitted from the server as an encrypted short message after authentication key renewal request and request, based on the sender number of the second remote service request message matching the sender number contained in the authentication configuration information, renewal authentication key information to the server to receive the renewal authentication key.

According to an embodiment, the processor may request, based on the sender number of the second remote service request message matching the sender number contained in the authentication key configuration information, the content of the second remote service request message to the server to receive an authentication key renewal request message and request, upon receiving the authentication key renewal request message, the renewal authentication key information from the server.

According to an embodiment of the disclosure, a vehicle terminal authentication key issuance system may include a server and a vehicle terminal.

According to an embodiment, the server may transmit authentication key configuration information to the vehicle terminal, transmit, in response to an authentication key issuance request from the vehicle terminal, a first remote service request message as an encrypted short message with a predetermined sender number, and transmit an authentication key to the vehicle terminal upon receiving an authentication key information request from the vehicle terminal.

According to an embodiment, the vehicle terminal may request, upon receiving the authentication configuration information, authentication key issuance to the server, receive the first remote service request message in response to the authentication key issuance request, and request, based on the sender number of the first remote service request message matching the sender number contained in the authentication key configuration information, authentication information to the server to receive the authentication key.

According to an embodiment, the vehicle terminal may request service activation to the server, and the server may transmit the authentication key configuration information in response to the service activation request.

According to an embodiment, the vehicle terminal may request, based on the sender number of the first remote service request message matching the sender number contained in the authentication configuration information, the content of the first remote service request message to the server to receive an authentication key storage request message and request, upon receiving the authentication key storage request message, the authentication key information to the server.

According to an embodiment, the vehicle terminal may request, based on an authentication key renewal period contained in the authentication configuration information, authentication key renewal to the server, and the server may transmit a renewal authentication key in response to the authentication key renewal request.

According to an embodiment, the vehicle terminal may receive, after the authentication key renewal request, a second remote service request message as an encrypted short message from the server and request, based on the sender number of the second remote service request message matching the sender number contained in the authentication key configuration information, renewal authentication key information to the server to receive the renewal authentication key.

According to an embodiment, the vehicle terminal may request, based on the sender number of the second remote service request message matching the sender number contained in the authentication key configuration information, the content of the second remote service request message to the server to receive an authentication key renewal request message and request, upon receiving the authentication key renewal request message, the renewal authentication key information to the server.

According to an embodiment of the disclosure, a vehicle terminal authentication key issuance method may include transmitting, by a server, authentication key configuration information to a vehicle terminal, requesting, by the vehicle terminal, authentication key issuance to the server upon receiving the authentication configuration information, transmitting, by the server, a first remote service request message as an encrypted short message with a predetermined sender number in response to an authentication key issuance request from the vehicle terminal, requesting, by the vehicle terminal, authentication key information to the server based on the sender number of the first remote service request message matching the sender number contained in the authentication key configuration information, and transmitting, by the server, an authentication key to the vehicle terminal in response to the authentication key information request from the vehicle terminal.

According to an embodiment, the authentication key configuration information may be transmitted in response to a service activation request from the vehicle terminal.

According to an embodiment, the requesting of authentication key information may include requesting, by the vehicle terminal, the content of the first remote service request message to the server to receive an authentication key storage request message based on the sender number of the first remote service request message matching the sender number contained in the authentication configuration information, and requesting, upon receiving the authentication key storage request message, the authentication key information to the server.

According to an embodiment, the vehicle terminal authentication key issuance method may further include requesting, by the vehicle terminal, authentication key renewal to the server based on an authentication key renewal period contained in the authentication configuration information, and receiving a renewal authentication key from the server.

According to an embodiment, the receiving of a renewal authentication key may include receiving, by the vehicle terminal, a second remote service request message as an encrypted short message from the server after the authentication key renewal request, and requesting, based on the sender number of the second remote service request message matching the sender number contained in the authentication key configuration information, renewal authentication key information to the server.

According to an embodiment, the requesting of renewal authentication key information to the server may include requesting, by the vehicle terminal, the content of the second remote service request message from the server, based on the sender number of the second remote service request message matching the sender number contained in the authentication key configuration information, to receive an authentication key renewal request message, and requesting, upon receiving the authentication key renewal request message, the renewal authentication key information to the server.

According to an embodiment of the disclosure, a vehicle may include a vehicle terminal configured to communicate with a server, wherein the vehicle terminal may receive authentication key configuration information from the server, request authentication key issuance to the server after receiving the authentication configuration information, receive a first remote service request message transmitted from the server as an encrypted short message after the authentication key issuance request, and request authentication key information to the server based on a sender number contained in the first remote service request message matching a sender number contained in the authentication key configuration information.

Additional details regarding various embodiments of the disclosure, beyond what has been described as solutions to the problems, are provided in the following descriptions and drawings.

According to an embodiment of the disclosure, it is advantageous to provide a vehicle terminal, a method and system for issuing an authentication key for the terminal, and a vehicle incorporating the terminal, all capable of enhancing security during the authentication key issuance process.

The authentication key issuance technology according to an embodiment of the disclosure is advantageous in terms of enhancing the security of the authentication key issuance process for the vehicle terminal by performing both key issuance and storage in the vehicle terminal based on communication between the vehicle terminal and the server.

It is also advantageous that the authentication key for the vehicle terminal can be automatically renewed through communication between the vehicle terminal and the server.

It is also advantageous that the expiration date and renewal period of the authentication key can be easily configured without requiring software changes to the vehicle terminal even when changes occur due to security policy updates since the expiration date and renewal period of the authentication key provided from the server to the vehicle terminal as configuration information.

The advantageous effects of this disclosure are not limited to the aforesaid, and other effects not described herein with can be clearly understood by those skilled in the art from the descriptions below.

The content of the problem to be solved, the means for solving the problem, and the effects mentioned above are not essential features of the claims, so the scope of the claims is not limited by the content disclosed in the disclosure.

### BRIEF DESCRIPTION OF THE DRAWINGS

The drawings attached below are provided to help understand the embodiments of the disclosure, along with detailed explanations. However, the technical features of the embodiments are not limited to a specific drawing, and the features disclosed in each drawing can be combined to form new embodiments.

FIG. 1 is a diagram illustrating the configuration of a vehicle terminal authentication key issuance system;

FIG. 2 is a flowchart illustrating an authentication key issuance method for a vehicle terminal;

FIG. 3 is a signal flow diagram illustrating the interaction between the vehicle terminal and the server;

FIG. 4 is a signal flow diagram illustrating the interaction between the vehicle terminal and the server;

FIG. 5 is a block diagram illustrating the configuration of the vehicle terminal; and

FIG. 6 is a block diagram illustrating the configuration of the server.

### DETAILED DESCRIPTION

Advantages and features of the disclosure and methods of accomplishing the same may be understood more readily by reference to the following detailed description of embodiments and the accompanying drawings. The disclosure can, however, be embodied in many different forms and should not be construed as being limited to the embodiments set forth herein; rather, these embodiments are provided so that the disclosure will be thorough and complete and will fully convey the concept of the disclosure to those skilled in the art, and the disclosure will only be defined by the appended claims.

The shapes, sizes, ratios, angles, numbers and the like illustrated in the drawings to describe embodiments of the disclosure are merely exemplary, and thus, the disclosure is not limited thereto. Throughout the specification, the same reference numerals refer to the same components. In addition, detailed descriptions of well-known technologies may be omitted in the disclosure to avoid obscuring the subject matter of the disclosure. In this specification, when terms such as “includes,” “has,” and “comprises,” are used, other elements may be added unless the term “only” is used. Unless otherwise explicitly stated, when a component is expressed in the singular form, it is intended to encompass the plural form as well.

In interpreting the components, it is construed to include a margin of error even in the absence of explicit description.

When a description involves a temporal relationship, such as “later,” “subsequently,” “next,” and “before,” non-consecutive situations may also be included unless the terms “immediately” or “directly” are used.

Although the terms “first,” “second,” and the like are used for describing various components, these components are not confined by these terms. These terms are merely used for distinguishing one component from the other components. Therefore, the first component mentioned hereinafter may be the second component in the technical sense of the disclosure.

When describing the components of the disclosure, terms such as “first,” “second,” “A,” “B,” “(a),” and “(b)” can be used. These terms are only used only to distinguish one component from another, and the nature, sequence, order, or quantity of the corresponding components are not limited by the term. When a component is described as being “connected,” “coupled,” or “joined” to another component, it should be understood that the component can be directly connected or joined to the other component, or another component may be “interposed” between them, unless explicitly stated otherwise.

The phrase “at least one” should be understood to include all combinations of one or more of the associated components. For example, the phrase “at least one of the first, second, and third components” means it includes not only the first, second, or third component individually but also any combination of two or more components among the first, second, and third components.

The various features of the embodiments of the disclosure can combined or assembled together, either partially or entirely, in a technically diverse manner, and each embodiment can be independently implemented or in conjunction with related embodiments.

Although depicted in a scale different from their actual scale for the convenience of explanation, the components are not limited to the scale shown in the drawing.

Hereinafter, descriptions are made of a vehicle terminal, a method and system for issuing an authentication key for the terminal, and a vehicle incorporating the terminal according to embodiments of the disclosure with reference to accompanying drawings.

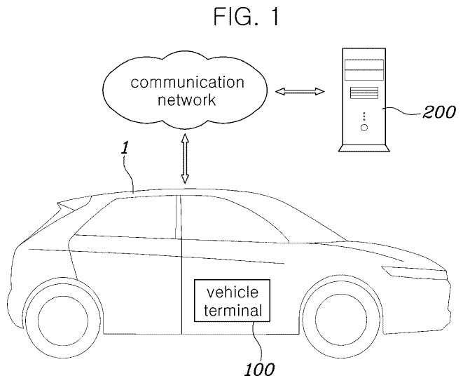

FIG. 1 is a diagram illustrating the configuration of a vehicle terminal authentication key issuance system according to an embodiment of the disclosure.

With reference to FIG. 1, the vehicle terminal authentication key issuance system (hereinafter referred to as the system) according to an embodiment of the disclosure may include a vehicle terminal 100 mounted on a vehicle 1 and a server 200.

In the disclosure, the vehicle 1 is connected to a communication network and may receive various information (e.g., road information, traffic information, driving routes, map information, weather information, etc.) and multimedia content (e.g., music, videos, etc.) from the server 200, and such a vehicle may be referred to as a “connected car.”

The vehicle terminal 100 is mounted on the vehicle 1 and serves as a device that provides multimedia, navigation, communication functions, and such a terminal may be referred to as a “connected car terminal.” For example, the vehicle terminal 100 may be implemented as an audio⋅video⋅navigation⋅telematics (AVNT) system, and the type of the vehicle terminal 100 is not limited to this configuration.

The vehicle terminal 100 and the server 200 are interconnected through a communication network, and the issuance of authentication keys (or tokens) for the vehicle terminal 100 may occur between the vehicle terminal 100 and the server 200.

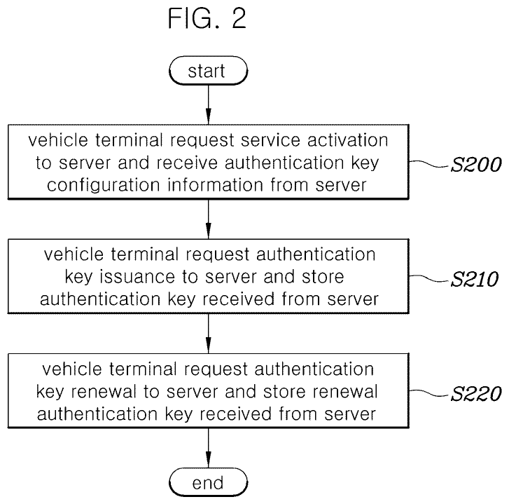

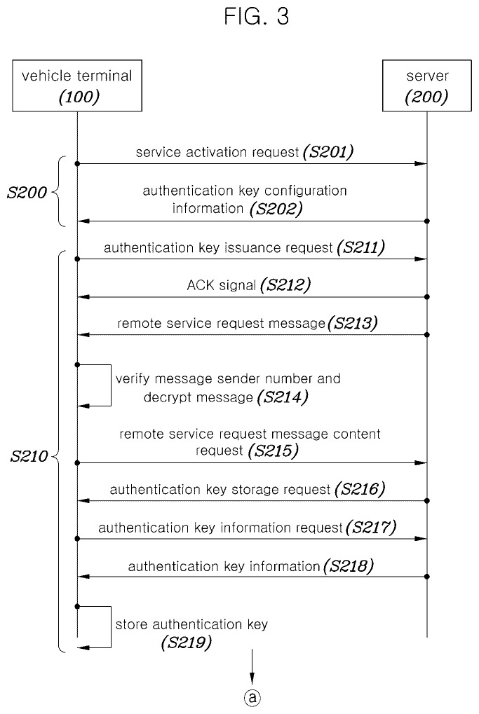

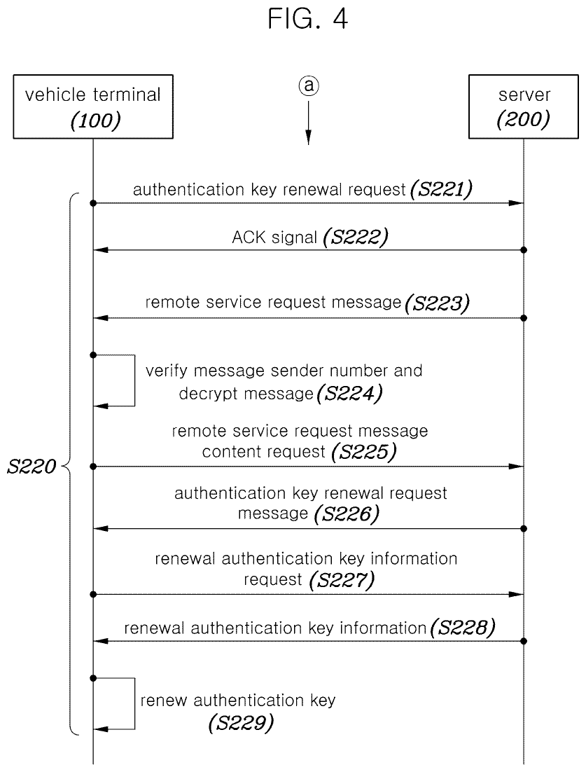

FIG. 2 is a flowchart illustrating an authentication key issuance method for a vehicle terminal 100 according to an embodiment of the disclosure, FIG. 3 is a signal flow diagram illustrating the interaction between the vehicle terminal 100 and the server 200 based on steps S200 and S210 in FIG. 2, and FIG. 4 is a signal flow diagram illustrating the interaction between the vehicle terminal 100 and the server 200 based on step S220 in FIG. 2.

With reference to FIG. 2, FIG. 3, and FIG. 4, the vehicle terminal 100 may receive authentication key configuration information from the server 200 in step S200.

In step S200, the vehicle terminal 100 may request service activation to the server 200 at sub-step S201, and the server 200 may activate the service for the vehicle terminal 100 and transmit authentication key configuration information to the vehicle terminal 100 at sub-step S202.

For example, authentication key configuration information may include the server message sender number (e.g., sender phone number), authentication key renewal period, number and interval of retries for authentication key issuance against failure, and authentication key issuance request timeout duration, with the information included in the authentication key configuration not being limited to these examples.

For example, the authentication key renewal period may be determined based on the expiration date of the authentication key. For example, the authentication key renewal period may be set as the time before the expiration date (e.g., 12 hours) when the renewal request should be initiated.

After receiving the authentication key configuration information, the vehicle terminal 100 may request authentication key issuance to the server 200 and receive the authentication key from the server 200 for storage.

In step S210, the vehicle terminal 100 may request authentication key issuance to the server 200 at sub-step S211, and the server 200 may transmit, at sub-step S212, an acknowledgment (ACK) signal in response to the authentication key issuance request from the vehicle terminal 100 and then transmit a remote service request message to the vehicle terminal 100 with a preset sender number (e.g., phone number) at sub-step S213.

For example, the remote service request message may be an encrypted short message (e.g., a Short Message Service (SMS) message).

The vehicle terminal 100 may receive the remote service request message transmitted from the server 200 and decrypt, in response that the sender number matches the preset sender number, the encrypted remote service request message at sub-step S214.

Afterward, the vehicle terminal 100 may request the content of the remote service request message to the server 200 at sub-step S215, and the server 200 may transmit an authentication key storage request message to the vehicle terminal 100 at sub-step S216.

Upon receiving the authentication key storage request message transmitted from the server 200, the vehicle terminal 100 may request authentication key information to the server 200 at sub-step S217, and the server 200 may transmit the authentication key information to the vehicle terminal 100 at sub-step S218.

The vehicle terminal 100 may store the authentication key information transmitted from the server 200 at sub-step S219.

For example, authentication key information may include an authentication key, a refresh authentication key, and/or an authentication key expiration date, with the information included in the authentication key information not being limited to these examples.

After storing the authentication key in step S210, the vehicle terminal 100 may request authentication key renewal to the server 200 based on the preset authentication key renewal period and store the renewed authentication key received from the server 200 in step S220.

In step S220, the vehicle terminal 100 may request authentication key renewal to the server 200 at sub-step S221. The server 200 may, upon receiving the authentication key renewal request from the vehicle terminal 100, transmit an ACK signal at sub-step S222. The server 200 may transmit a remote service request message to the vehicle terminal 100 using the preset sender number (e.g., phone number) at sub-step S223.

For example, the remote service request message may be an encrypted Short Message Service (SMS) message.

The vehicle terminal 100 may receive the remote service request message transmitted from the server 200 and decrypt, in response that the sender number matches the preset sender number, the encrypted remote service request message at sub-step S224.

Subsequently, the vehicle terminal 100 may request the content of the remote service request message to the server 200 at sub-step S225, and the server 200 may transmit an authentication key renewal request message to the vehicle terminal 100 at sub-step S226.

Upon receiving the authentication key renewal request message from the server 200, the vehicle terminal 100 may request renewal authentication key information to the server 200 at sub-step S227, and the server 200 may transmit the renewal authentication key information to the vehicle terminal 100 at sub-step S228.

At sub-step S229, the vehicle terminal 100 may renew the authentication key based on the renewal authentication key information transmitted from the server 200.

For example, the renewal authentication key information may include the renewal authentication key, refresh authentication key, and expiration date of the renewal authentication key, with the information included in the renewal authentication key information not being limited to these examples.

According to an embodiment of the disclosure, since the process of issuing an authentication key for the vehicle terminal 100 and the process of storing authentication key in the vehicle terminal 100 are performed based on communication between the vehicle terminal 100 and the server 200, the security of the authentication key issuance procedure for the vehicle terminal 100 can be enhanced.

Additionally, the renewal of the authentication key for the vehicle terminal 100 can occur automatically between the vehicle terminal 100 and the server 200.

Furthermore, since the expiration date and renewal period of the authentication key are provided as configuration information from the server 200 to the vehicle terminal 100, even when changes occur due to security policy updates, the expiration date and renewal period of the authentication key can be easily set without requiring software changes to the vehicle terminal 100.

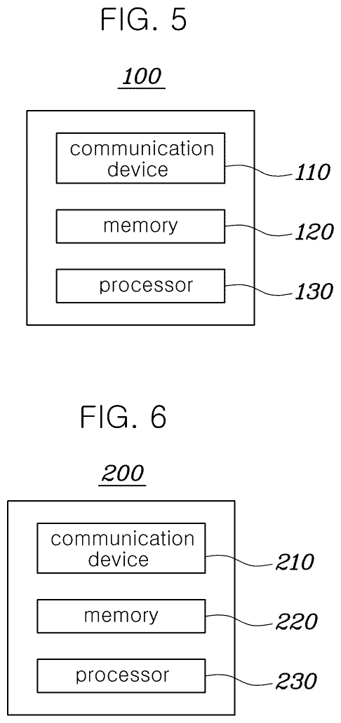

FIG. 5 is a block diagram illustrating the configuration of the vehicle terminal 100 according to an embodiment of the disclosure.

With reference to FIG. 5, the vehicle terminal 100 may include a communication device (e.g., module) 110, a memory 120, and a processor 130, and the configuration of the vehicle terminal 100 is not limited thereto.

The communication device 110 may connect to the communication network using a predetermined wireless communication method and communicate with the server 200 through the network.

For example, the communication device 110 and the communication network may employ various communication technologies including wireless Internet technologies such as wireless local area network (WLAN, Wi-Fi), wireless broadband (Wibro), and world interoperability for microwave access (Wimax), short-range communication technologies such as Bluetooth, near field communication (NFC), radio frequency identification (RFID), and infrared data association (IrDA), and mobile communication technologies such as code division multiple access (CDMA), global system for mobile communication (GSM), long-term evolution (LTE), LTE-Advanced, and international mobile telecommunication-2020 (IMT-2020). A communication device (e.g., communication device 110, communication device 210) may be, for example, a network adapter, a modem, a transmitter, a receiver, a radio wave transceiver, an antenna, etc.

The memory 120 may store software programmed for the processor 130 to perform predetermined operations.

The memory 120 may be implemented with at least one storage medium (recording medium) such as flash memory, hard disk, secure digital (SD) card, random access memory (RAM), static RAM (SRAM), read only memory (ROM), programmable ROM (PROM), electrically erasable and programmable ROM (EEPROM), erasable and programmable ROM (EPROM), registers, removable disks, and web storage.

The memory 120 may receive and store token information, renewal token information, etc. transmitted from the server 200 via the communication device 110.

The processor 130 may execute operations or data processing related to the control of at least one other component of the vehicle terminal 100. For example, the processor 130 may execute software stored in the memory 120.

The processor 130 may process received data as well as data stored in the memory 120. The processor 130 may execute computer-readable code (e.g., algorithms) stored in the memory 120 and instructions triggered by the processor 130.

The processor 130 may be implemented as a hardware data processing device with a circuit having a physical structure to execute desired operations. For example, the desired operations may encompass codes or instructions included in the program.

For example, the hardware-implemented data processing device may encompass microprocessors, central processing units (CPUs), processor cores, multi-core processors, multiprocessors, application-specific integrated circuits (ASICs), and field programmable gate arrays (FPGAS).

According to an embodiment, the processor 130 may communicate with the server 200 via the communication device 110 and perform operations to store authentication keys transmitted from the server 200 and to update authentication keys based on renewal authentication keys transmitted from the server 200.

FIG. 6 is a block diagram illustrating the configuration of the server 200 according to an embodiment of the disclosure.

With reference to FIG. 6, the server 200 according to an embodiment of the disclosure may include a communication device (e.g., module) 210, a memory 220, and a processor 230, and the configuration of the server 200 is not limited thereto.

The communication device 210 may connect to the communication network using a predetermined wireless communication method and communicate with the vehicle terminal 100 through the network.

For example, the communication network may employ various communication technologies including wireless Internet technologies such as wireless local area network (WLAN, Wi-Fi), wireless broadband (Wibro), and world interoperability for microwave access (Wimax), short-range communication technologies such as Bluetooth, near field communication (NFC), radio frequency identification (RFID), and infrared data association (IrDA), and mobile communication technologies such as code division multiple access (CDMA), global system for mobile communication (GSM), long-term evolution (LTE), LTE-Advanced, and international mobile telecommunication-2020 (IMT-2020).

The memory 220 may store software programmed for the processor 230 to perform predetermined operations.

The memory 220 may be implemented with at least one storage medium (recording medium) such as flash memory, hard disk, secure digital (SD) card, random access memory (RAM), static RAM (SRAM), read only memory (ROM), programmable ROM (PROM), electrically erasable and programmable ROM (EEPROM), erasable and programmable ROM (EPROM), registers, removable disks, and web storage.

The memory 220 may store authentication key information, renewal authentication key information, sender number, etc. related to the vehicle terminal 100.

The processor 230 may execute operations or data processing related to the control of at least one other component of the server 200. For example, the processor 230 may execute software stored in the memory 220.

The processor 230 may process received data as well as data stored in the memory 220. The processor 230 may execute computer-readable code (e.g., algorithms) stored in the memory 220 and instructions triggered by the processor 230.

The processor 230 may be implemented as a hardware data processing device with a circuit having a physical structure to execute desired operations. For example, the desired operations may encompass codes or instructions included in the program.

For example, the hardware-implemented data processing device may encompass microprocessors, central processing units (CPUs), processor cores, multi-core processors, multiprocessors, application-specific integrated circuits (ASICs), and field programmable gate arrays (FPGAS).

According to an embodiment, the processor 230 may communicate with the vehicle terminal 100 via the communication device 210 and perform operations to transmit authentication keys to the vehicle terminal 100 and to transmit renewal authentication keys to the vehicle terminal 100.

The embodiments of the disclosure have been described in detail with reference to the accompanying drawings, but the disclosure is not limited to these embodiments, and can be modified and practiced in a variety of ways without departing from the scope of the technical concept of the disclosure. Therefore, the embodiments disclosed in this specification are not intended to limit but to describe the technical idea of the disclosure, and the scope of the technical idea of the disclosure is not limited by the embodiments. Therefore, it should be understood that the embodiments described above are exemplary and not limited in all aspects. The scope of the disclosure should be interpreted in accordance with the claims set forth below, and all equivalent technical concepts should be considered as included in the scope of protection of the disclosure.

What is claimed is:

1. A vehicle terminal comprising:
a communication device configured to communicate with a server; and
a processor configured to:
receive, from the server, authentication key configuration information associated with a first sender number;
send, to the server and after receiving the configuration information, an authentication key authentication key issuance request;
receive, from the server, an encrypted message, wherein the encrypted message comprises a first remote service request message associated with a second sender number;
send, to the server and based on the second sender number associated with the first remote service request message matching the first sender number associated with the authentication key configuration information, an authentication key information request;
receive, from the server, authentication key information; and
cause, based on the authentication key information, communication between the communication device and the server.

2. The vehicle terminal of claim 1, wherein the encrypted message is an encrypted Short Message Service (SMS) message.

3. The vehicle terminal of claim 1, wherein the processor is configured to receive the authentication key configuration information by:
sending, to the server, a service activation request; and
receiving the authentication key configuration information in response to the service activation request.

4. The vehicle terminal of claim 1, wherein the processor is configured to send the authentication key information request by:
sending, based on the second sender number associated with the first remote service request message matching the first sender number associated with the authentication key configuration information, a request for content of the first remote service request message;
receiving, from the server, an authentication key storage request message; and
server and after receiving the sending, to the authentication key storage request message, the authentication key information request.

5. The vehicle terminal of claim 1, wherein the authentication key configuration information comprises an indication of an authentication key renewal period, and wherein the processor is further configured to:
send, to the server and based on the authentication key renewal period, an authentication key renewal request; and
receive, from the server, a renewal authentication key in response to the authentication key renewal request.

6. The vehicle terminal of claim 5, wherein the processor is further configured to:
receive, from the server and after sending the authentication key renewal request, a second encrypted message comprising a second remote service request message associated with a third sender number; and
send, based on the third sender number associated with the second remote service request message matching the first sender number associated with the authentication key configuration information, an authentication key information renewal request.

7. The vehicle terminal of claim 6, wherein the processor is configured to send the authentication key information renewal request by:
sending, to the server and based on the third sender number associated with the second remote service request message matching the sender number associated with the first authentication key configuration information, a request for content of the second remote service request message;
receiving, from the server, an authentication key renewal request message; and
sending, to the server and after receiving the authentication key renewal request message, the authentication key information renewal request.

8. A system comprising:
a server; and
a vehicle terminal,
wherein the server is configured to:
send, to the vehicle terminal, authentication key configuration information associated with a first sender number;
send, in response to an authentication key issuance request from the vehicle terminal, an encrypted message, wherein the encrypted message comprises a first remote service request message associated with a second sender number; and
send, to the vehicle terminal and after receiving an authentication key information request, an authentication key, and
wherein the vehicle terminal is configured to:
send, to the server and after receiving the authentication key configuration information, the authentication key issuance request;
receive, from the server and after sending the authentication key issuance request, the encrypted message;
send, to the server and based on the second sender number associated with the first remote service request message matching the first sender number associated with the authentication key configuration information, the authentication key information request;
receive, from the server, authentication key information; and
using the authentication key information, communicate with the server.

9. The system of claim 8, wherein the vehicle terminal is further configured to:
send, to the server, a service activation request, and
wherein the server is configured to send the authentication key configuration information in response to the service activation request.

10. The system of claim 8, wherein the vehicle terminal is configured to send the authentication key information request by:
sending, based on the second sender number associated with the first remote service request message matching the first sender number associated with the authentication key configuration information, a request for content of the first remote service request message; and
receiving, from the server, an authentication key storage request message; and
sending, to the server and after receiving the authentication key storage request message the authentication key information request.

11. The system of claim 8, wherein the authentication key configuration information comprises an indication of an authentication key renewal period, and wherein the vehicle terminal is further configured to:
send, to the server and based on the authentication key renewal period, an authentication key renewal request, and
wherein the server is configured to transmit, in response to the authentication key renewal request, a renewal authentication key.

12. The system of claim 11, wherein the vehicle terminal is further configured to:
receive, from the server and after sending the authentication key renewal request, a second encrypted message comprising a second remote service request message associated with a third sender number; and
send, based on the third sender number associated with the second remote service request message matching the first sender number associated with the authentication key configuration information, an authentication key information renewal request.

13. The system of claim 12, wherein the vehicle terminal is configured to send the authentication key information renewal request by:
sending, to the server and based on the third sender number associated with the second remote service request message matching the sender first number associated with the authentication key configuration information, a request for content of the second remote service request message;
receiving, from the server, an authentication key renewal request message; and
sending, to the server and after receiving the authentication key renewal request message, the authentication key information renewal request.

14. A method performed by a vehicle terminal, the method comprising:
receiving, from a server, authentication key configuration information associated with a first sender number;
sending, to the server and after receiving the authentication key configuration information, an authentication key issuance request;
receiving, from the server, an encrypted message, wherein the encrypted message comprises a first remote service request message associated with a second sender number;
sending, to the server and based on the second sender number associated with the first remote service request message matching the first sender number associated with the authentication key configuration information, an authentication key information request;
receiving, from the server, authentication key information; and
using the authentication key information, communicating with the server.

15. The method of claim 14, further comprising: before receiving the authentication key configuration information, sending, to the server, a service activation request.

16. The method of claim 14, wherein the sending of the authentication key information request comprises:
sending, based on the second sender number associated with the first remote service request message matching the first sender number associated with the authentication key configuration information, a request for content of the first remote service request message; and
receiving, from the server, an authentication key storage request message; and
sending, to the server and after receiving the authentication key storage request message, the authentication key information request.

17. The method of claim 14, wherein the authentication key configuration information comprises an indication of an authentication key renewal period, and wherein the method further comprises:
sending, to the server and based on the authentication key renewal period, an authentication key renewal request; and
receiving, from the server, a renewal authentication key in response to the authentication key renewal request.

18. The method of claim 17, further comprising:
receiving, from the server and after sending the authentication key renewal request, a second encrypted message comprising a second remote service request message associated with a third sender number; and
sending, based on the third sender number associated with the second remote service request message matching the first sender number associated with the authentication key configuration information, an authentication key information renewal request.

19. The method of claim 18, wherein the sending of the authentication key information renewal request comprises:
sending, to the server and based on the third sender number associated with the second remote service request message matching the first sender number associated with the authentication key configuration information, a request for content of the second remote service request message;
receiving, from the server, an authentication key renewal request message; and
sending, to the server and after receiving the authentication key renewal request message, the authentication key information renewal request.

20. A vehicle comprising:
a power source configured to provide power for a driving operation of the vehicle; and
the vehicle terminal of claim 1.
